(19) United States
(12) Patent Application Publication
(10) Pub. No.: US 2017/0075963 A1
(43) Pub. Date: Mar. 16, 2017

(54) METHODS AND SYSTEMS FOR CAPTURING RELATIONAL CONTENT, OBJECTIVELY ORDERING SEARCH RESULTS, AND CONCISELY DISPLAYING SEARCH RESULTS

(71) Applicant: Knowtro, Inc., Burlington, NC (US)

(72) Inventors: Sean R. McMahon, Burlington, NC (US); Isaac N. Cummings, Whitsett, NC (US)

(21) Appl. No.: 15/263,272

(22) Filed: Sep. 12, 2016

Related U.S. Application Data
(60) Provisional application No. 62/217,787, filed on Sep. 11, 2015.
(60) Provisional application No. 62/281,356, filed on Jan. 21, 2016.

(51) Int. Cl. G06F 17/30

(52) U.S. Cl. CPC G06F 17/30554; G06F 17/30321; G06F 17/30595

(57) ABSTRACT

A method and system for capturing relational data, objectively ordering search results, and displaying search results are disclosed herein. The method includes using a computing device, including at least one processor and memory, for receiving content comprising one of scientific, academic, and research-oriented data from a content source. The method also includes determining one or more measured variables related to the one of scientific, academic, and research-oriented data of the content. The method also includes determining one or more relationships between the received content and previously received content based on the determined one or more measured variables. Further, the method includes communicating the one or more relationships to one or more relational databases configured to index the one or more relationships.

### CROSS REFERENCE TO RELATED APPLICATIONS

This application claims the benefit of U.S. Provisional Patent Application No. 62/217,787, filed Sep. 11, 2015 and titled METHOD AND SYSTEM FOR CONCISE, OBJECTIVE, RELATIONAL (COR) ONLINE SEARCH AND SEARCH RESULTS DISPLAY, and claims the benefit of U.S. Provisional Patent Application No. 62/281,356, filed Jan. 21, 2016 and titled METHOD AND SYSTEM FOR CAPTURING RELATIONAL CONTENT, OBJECTIVELY ORDERING SEARCH RESULTS, AND CONCISELY DISPLAYING SEARCH RESULTS; the disclosures of which are incorporated by reference in their entireties.

### TECHNICAL FIELD

Embodiments described herein relate to capturing data, ordering search results, and displaying search results. More particularly, embodiments described herein relate to a method and system for capturing relational content, objectively ordering search results, and concisely displaying search results.

### BACKGROUND

Existing online search engine methods and systems typically use some sort of a text comparison algorithm that compares user inputted search terms to a library of content in order to determine which information sources are relevant and which are not. Search results from known search engines typically order the search results based on a variety of subjective parameters: a web page's popularity, the user's geographic location, the time the website was published, and the like. In addition, the search results are typically displayed by showing highlighted, hyperlinked titles and information residing at a general level of association with a result (e.g., author names, publishing website or journal name, summary abstract) with any accompanying excerpts of the content selected due to a match with user inputted search terms, but without any further validation.

However, if a user wishes to search for easily understandable and empirical scientific and academic information extracted from reliable sources, existing online search engines provide sub-optimal results. For example, a web page's popularity is a poor indicator of solid scientific knowledge associated with the web page. Similarly, sorting search results by citations for scientific and academic information serve only as an inexact proxy for quality via the popularity of authors or subject matter. Also, search results depicting only general level aspects of an information source fail to clearly identify, or completely overlook, more specific levels of validation residing in various pieces of information contained in a particular source. Therefore, there is a need to provide users with a system and technique to search and obtain scientific and academic information easily and review such search results in a concise and reliable manner.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are methods and systems for capturing relational data, objectively ordering search results, and displaying search results. According an aspect, a method includes using a computing device, including at least one processor and memory, for receiving content comprising one of scientific, academic, and research-oriented data from a content source. The method also includes determining one or more measured variables related to the one of scientific, academic, and research-oriented data of the content. The method also includes determining one or more relationships between the received content and previously received content based on the determined one or more measured variables. Further, the method includes communicating the one or more relationships to one or more relational databases configured to index the one or more relationships.

According to another aspect, a method includes using a computing device, including at least one method or and memory, for receiving a search request of one or more search terms. The method also includes determining one or more relationships between the search terms and one or more measured variables associated with the content in one or more relational databases. The method also includes identifying one or more search results based on the determined relationships between the one or more search terms and the one or more measured variables. The method also includes identifying one or more objective values associated with each search result of the one or more search results. The method also includes determining an order of presentation of the identified one or more search results based on the identification of the one or more objective values. Further, the method includes presenting the search results based on the determined order of presentation.

According to another aspect, a method includes using a computing device, including at least one processor and memory, for receiving search results for presentation via a user interface. The method also includes identifying one or more measured variables for each search result of the search results. Further, the method includes determining one of a text description and graphical description of each identified one or more measured variables for each search result of the search results. The method also includes presenting the determined one of a text description and graphical description of each identified one or more measured variables for each search result of the search results via the user interface.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 is a block diagram of an example system configured to perform the method determining one or more relationships between the received content and previously received content in accordance with embodiments of the present disclosure.

FIG. 2 is a flowchart of an example method for determining one or more relationships between the received content and previously received content in accordance with embodiments of the present disclosure.

FIG. 3A is a screen display of an example user interface for receiving identification of the one or more measured variables with embodiments of the present disclosure.

FIG. 3B is a screen display of another example user interface for receiving identification of the one or more measured variables with embodiments of the present disclosure.

FIG. 4 is a flowchart of an example method of comparing one or more measured variables to previously determined measured variables related to the previously received content.

FIG. 5 is a screen display of an example user interface displaying previously determined measured variables for selection in accordance with embodiments of the present disclosure.

FIG. 6(A-B) is a flow diagram of an example method of determining one or more measured variables related to a subject matter of content in accordance with embodiments of the present disclosure.

FIG. 7 is a flowchart of an example method of determining one or more objective values associated with the one or more measured variables in accordance with embodiments of the present disclosure.

FIG. 8A is a screen display of an example user interface for receiving a sample type and sample description objective value in accordance with embodiments of the present disclosure.

FIG. 8B is a screen display of an example user interface for receiving an analysis type objective value in accordance with embodiments of the present disclosure.

FIG. 9 is a flowchart of an example method of determining one or more relationships between search terms and one or more measured variables associated with content in a relational database in accordance with embodiments of the present disclosure.

FIG. 10 is a block diagram of an example system configured to perform the method of determining one or more relationships between search terms and one or more measured variables associated with content in a relational database in accordance with embodiments of the present disclosure.

FIG. 11A is a screen display of an example user interface displaying search results in accordance with embodiments of the present disclosure.

FIG. 11B is a screen display of another example user interface displaying search results in accordance with embodiments of the present disclosure.

FIG. 12 is a flowchart of an example method of determining one of a text description and a graphical depiction of each identified one or more measured variables for each search result of the search results in accordance with embodiments of the present disclosure.

FIG. 13 is a block diagram of example system configured to perform the method of determining one of a text description and a graphical depiction of each identified one or more measured variables for each search result of the search results in accordance with embodiments of the present disclosure.

FIG. 14 is a flowchart of an example method determining at least one of a predictor variable text description, coefficient text description, coefficient unit text, and outcome text description for the one or more measured variables in accordance with embodiments of the present disclosure.

FIG. 15A is a screen display of an example user interface for displaying a text description and graphical depiction of each identified one or more measured variables for each search result of search results in accordance with embodiments of the present disclosure.

FIG. 15B is a screen display of another example user interface for displaying a text description and graphical depiction of each identified one or more measured variables for each search result of search results in accordance with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Articles “a” and “an” are used herein to refer to one or to more than one (i.e. at least one) of the grammatical object of the article. By way of example, “an element” means at least one element and can include more than one element.

In this disclosure, “comprises,” “comprising,” “containing” and “having” and the like can have the meaning ascribed to them in U.S. patent law and can mean “includes,” “including,” and the like; “consisting essentially of” or “consists essentially” likewise has the meaning ascribed in U.S. patent law and the term is open-ended, allowing for the presence of more than that which is recited so long as basic or novel characteristics of that which is recited is not changed by the presence of more than that which is recited, but excludes prior art embodiments.

Ranges provided herein are understood to be shorthand for all of the values with the range. For example, a range of 1 to 50 is understood to include any number, combination of numbers, or sub-range from the group consisting 1, 2, 3, 4, 5, 6, 7, 8, 9, 10, 11, 12 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

Unless otherwise defined, all technical terms used herein have the same meaning as commonly understood by one of ordinary skill in the art to which this disclosure belongs.

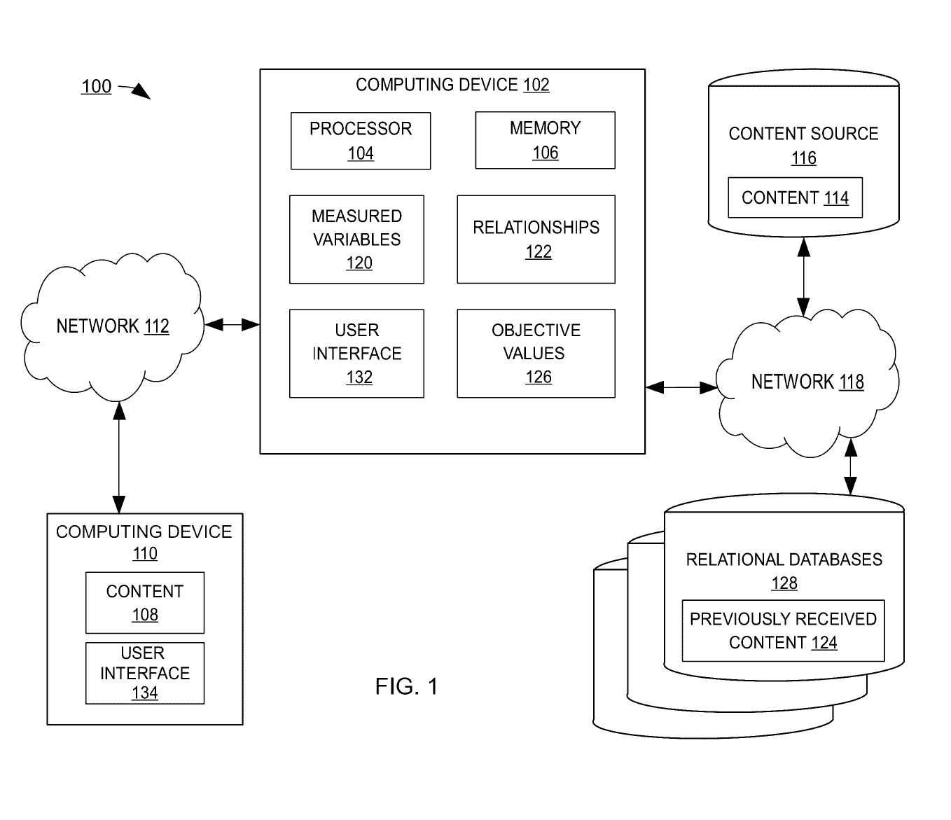

The present disclosure herein describes the systems and methods for capturing relational data, objectively ordering search results, and displaying search results in accordance with embodiments of the present invention. In accordance with embodiments, the system of the present disclosure comprises a computing device comprising a processor and memory for executing the steps of the methods of the present disclosure. For example, FIG. 1 illustrates a system 100 comprising a computing device 102 comprising a processor 104 and memory 106 configured to store and execute computer programming instructions to cause computing device 102 to perform the methods of the present disclosure as discussed herein below. In accordance with embodiments, the computing device may be configured to operate specifically as a server configured to perform the methods of the present disclosure discussed herein below.

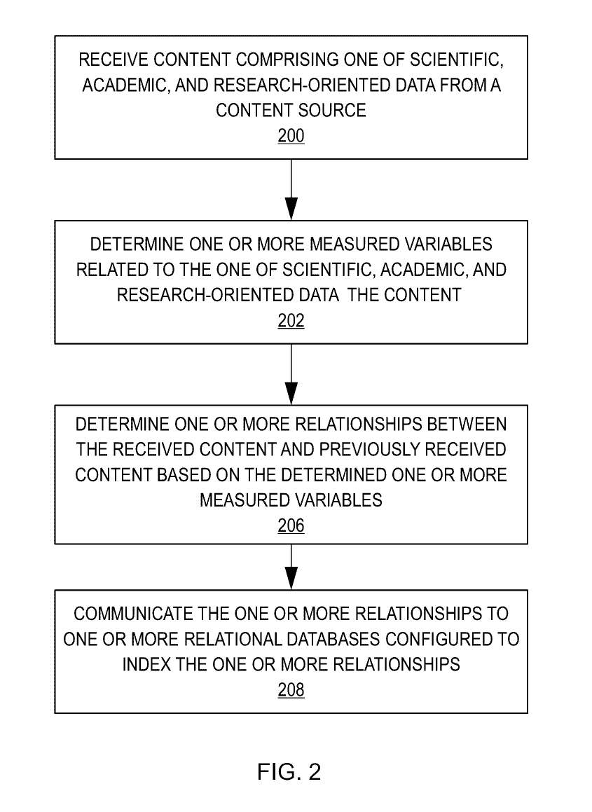

FIG. 2 illustrates an example method for determining one or more relationships between the received content and previously received content in accordance with embodiments of the present disclosure. The method includes receiving 200 content comprising one of scientific, academic, and research-oriented data from a content source. In accordance with embodiments, the content source may comprise another computing device in communication with the computing device. For example, FIG. 1 illustrates computing device 102 may be configured to receive content 108 from computing device 110 via communication network 112. In an embodiment, computing device 110 may comprise another computing device, such as, but not limited to, a mobile computing device, personal computing device, computing server, and the like. In the same embodiment, communication network 112 may comprise any wired or wireless network configured to enable communications between computing device 102 and computing device 110, such as, but not limited to, broadband communication networks, local area communication networks, wireless wide area communication networks (WWAN), wireless local area communication networks (WLAN), fiber-optic communication networks, and the like.

In accordance with embodiments, the content source may comprise a database associated with the one of scientific, academic, or research-oriented data. Continuing the above example, computing device 102 may also be configured to receive content 114 from content source 116 via network 118. In one embodiment, content source 116 may comprise a computing device configured to operate as a database to store and index content 114. In the same embodiment, communication network 118 may comprise any wired or wireless network configured to enable communications between computing device 102 and content source 116, such as, but not limited to, broadband communication networks, local area communication networks, wireless wide area communication networks (WWAN), wireless local area communication networks (WLAN), fiber-optic communication networks, storage area networks (SAN) and the like. Although only computing device 110 and content source 116 are shown, one of ordinary skill in the art would appreciate that computing device 102 may be configured receive content from multiple content sources and that computing device 102 is not limited to receiving content from only two content sources 110 and 116.

Returning to FIG. 2, the method also includes determining 202 one or more measured variables related to the one of scientific, academic, and research-oriented data of the content. For example, FIG. 1 illustrates computing device 102 may be configured to determine one or more measured variables 120 related to the one of scientific, academic, and research-oriented data of the content. In accordance with embodiments, the one or more measured variables may comprise one of a predictor variable and outcome variable associated with the one of scientific, academic, and research-oriented data of the content. In accordance with embodiments, the predicator variable may indicate an initial variable within the data of the content used to generate a result. In accordance with embodiments, the outcome variable may indicate a variable of measurement within the data of the content. Also in accordance with embodiments, the variable of measurement may indicate an effect that is altered by the value of the predictor variable.

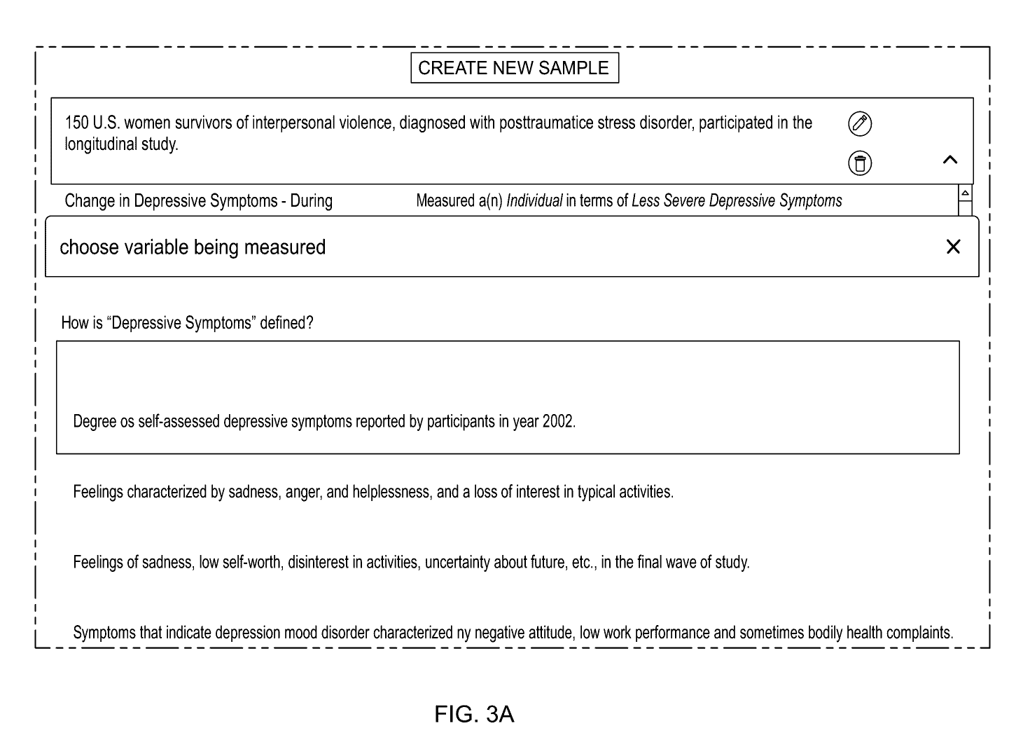

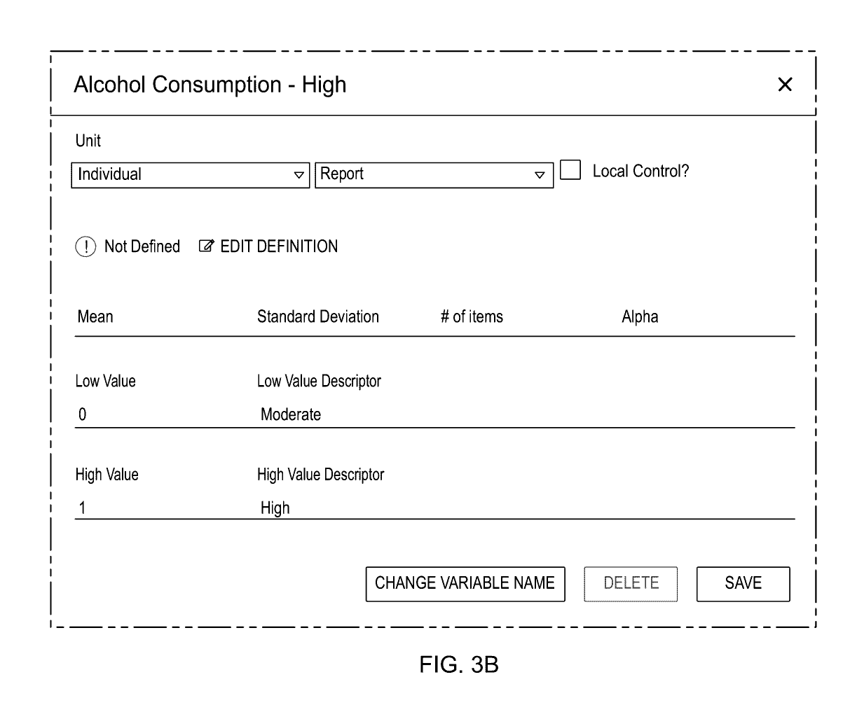

In accordance with embodiments, the method also includes determining the one or more measured variables may comprise receiving identification of the one or more measured variables. For example, computing device 102 may be configured to receive identification of the one or more measured variables 120 from computing device 110. FIG. 3A is a screen display of an example user interface for receiving identification of the one or more measured variables with embodiments of the present disclosure. In this example, user interface 134 of computing device 110 may be configured to receive the identification of the one or more measured variables. Although not shown, it should be understood that computing device 110 may comprise a display for displaying user interface 134 to a user of computing device 110. For example, FIG. 3A illustrates an example user interface for receiving identification of the measured variable “Alcohol Consumption—High” identified by one of a unit type, report type, local control type, definition, mean, standard deviation, low value, low value description, high value, and high value descriptor. FIG. 3B is a screen display of another example user interface for receiving identification of the one or more measured variables with embodiments of the present disclosure. For example, FIG. 3B illustrates an example user interface for receiving identification of the measured variable “Alcohol Consumption—High” and information associated with the measured variable. In accordance with embodiments, the method of receiving the identification of the one or more measured variables may comprise analyzing the one of scientific, academic, and research-oriented data and selecting the one or more measured variables based on the analysis.

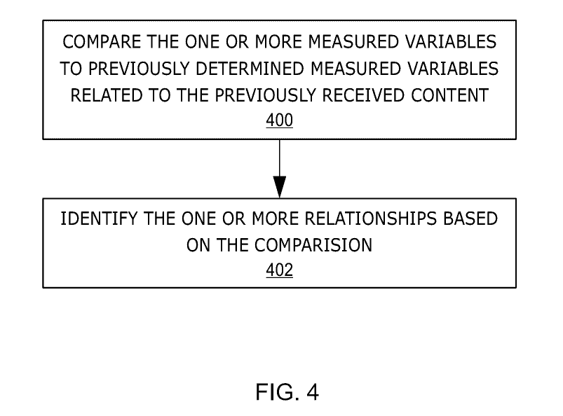

FIG. 2 illustrates the method also includes determining 204 one or more relationships between the received content and previously received content based on the determined one or more measured variables. For example, FIG. 1 illustrates computing device 102 may be configured to determine one or more relationships 122 between the received content 108 and 114 and previously received content 124 based on the determined one or more measured variables 120. In an embodiment, the method of determining 204 the one or more relationships between the received content and previously received content based on the determined one or more measured variables may also include comparing 400 the one or more measured variables to previously determined measured variables related to the previously received content, as shown in FIG. 4. Returning to FIG. 1, as an example, computing device 102 may be configured to compare the one or more measured variables 120 to previously determined measured variables related to previously received content 124. In one embodiment, the previously determined measured variables are stored along with the previously received content in one or more relational databases. Also shown in FIG. 4, the method may also include identifying 402 the one or more relationships based on the comparison. Continuing the previous example, computing device 102 may also be configured to identify the one or more relationships 122 based on the comparison.

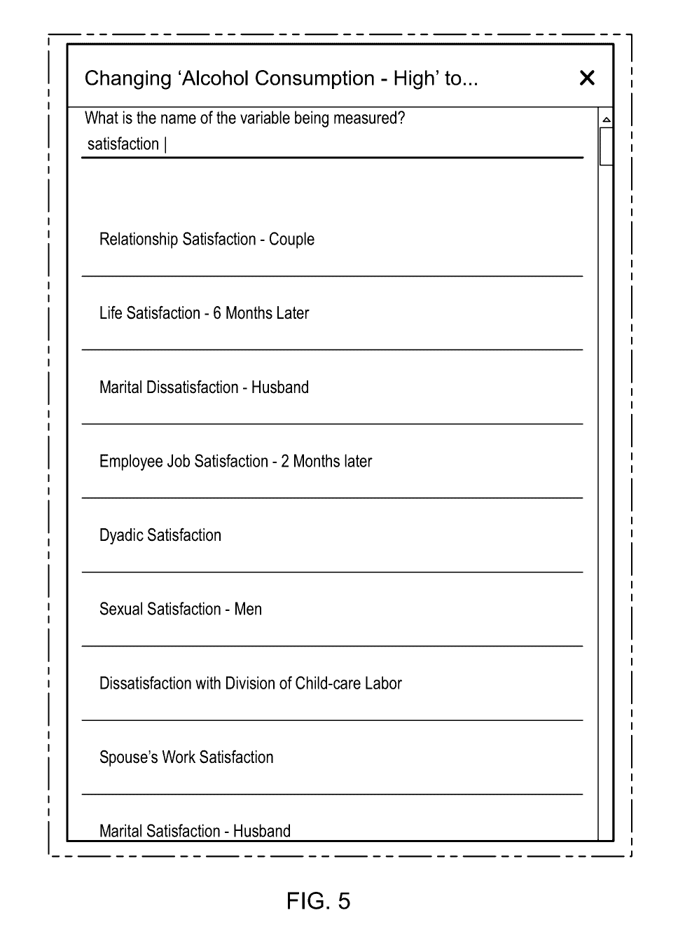

FIG. 5 is a screen display of an example user interface displaying previously determined measured variables for selection in accordance with embodiments of the present disclosure. As shown in FIG. 5, computing device 102 may be configured to display a list of previously determined example measured variables, such as, but not limited to, “Relationship Satisfaction—Couple,” “Employee Job Satisfaction—2 Months Later,” and “Spouse's Work Satisfaction” based on the determined measured variable “satisfaction.” In one embodiment, identifying 402 the one or more relationships based on the comparison may comprise receiving a selection of the one or more previously determined measured variables. For example, computing device 102 may be configured to identify the one or more relationships 122 by receiving a selection of one of the previously determined measured variables from such a list as shown in FIG. 5.

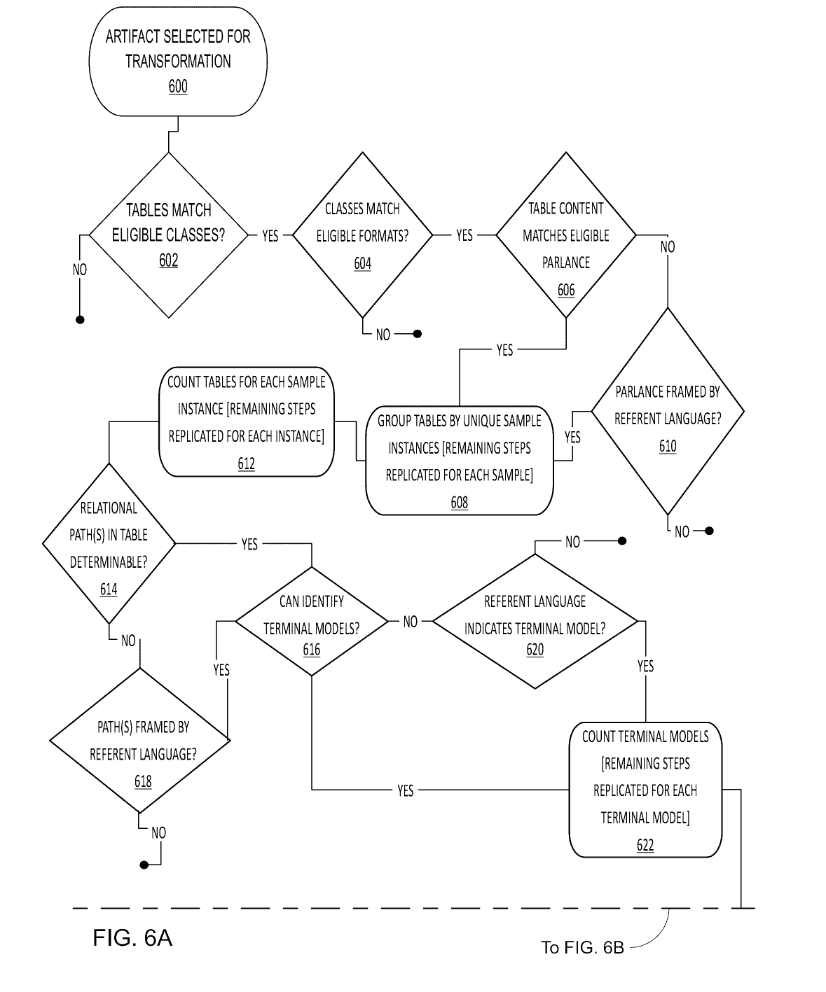

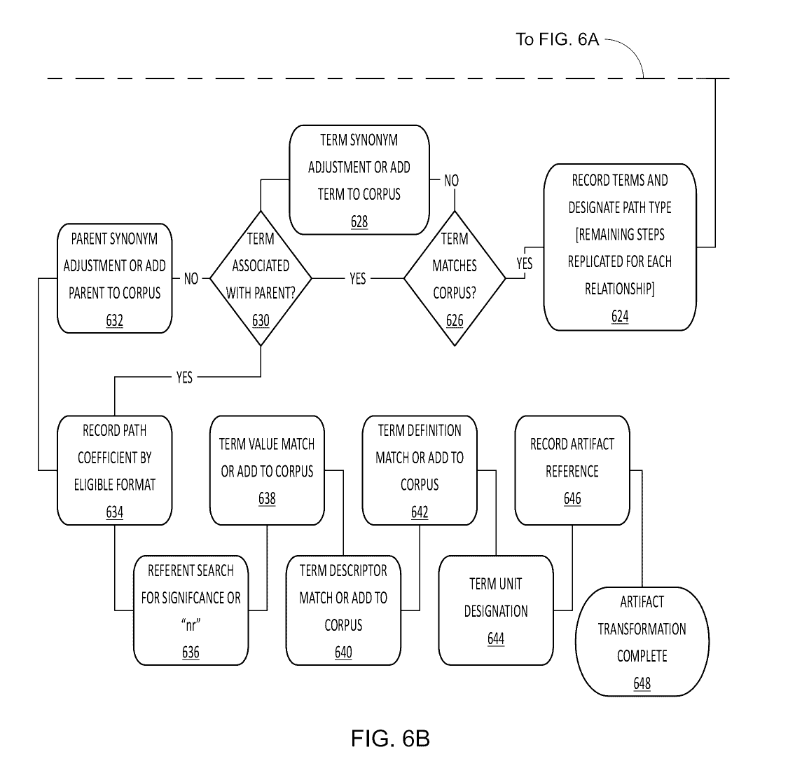

In accordance with embodiments, FIG. 6 illustrates an example method of determining one or more relationships between the received content and previously received content based on the determined one or more measured variables. As shown in FIG. 6, a method of determining one or more measured variables may comprise selecting 600 an artifact for transformation. In accordance with embodiments, such an artifact may comprise one of a scientific, academic, or research-oriented paper. FIG. 6 also illustrates the method may also include determining whether tables match 602 a set of eligible classes. In accordance with embodiments, a table may refer to the presence or absence of numeric characters typically associated with relational data. Also in accordance with embodiments, an eligible class of a table warranting inclusion of an artifact for the consideration in the next step of the transformation sequence would be an actual table depicting numeric values appearing at the intersection of a matrix where the term on the horizontal axis is a predictor (outcome) of some change in the outcome (predictor) term on the vertical axis. One of ordinary skill in the art may appreciate that though the term ‘table’ is used because the common eligible class is an actual table, certain types of diagrams and even general text containing numeric values may be considered an eligible class of table sufficient enough to send the artifact to the next step of transformation.

As shown in FIG. 6, the method may also include determining whether the eligible classes match 604 eligible formats. In accordance with embodiments, eligible formats refer to the presence or absence of relational data. For example, a depiction of results of various types of regression results, including, but not limited to, multiple regression and logistic regression. In accordance with embodiments, formats considered ineligible include eligible classes articulating descriptive statistics but not containing relational data. For example, a number count or percentage of females that participated in an empirical study but no relational data regarding the relationship between being female and the likelihood of becoming an entrepreneur would be considered an ineligible format.

The method may also include determining whether the table(s) content matches 606 eligible parlance. In accordance with embodiments, eligible parlance refers to the presence or absence of conclusive relational data. Also in accordance with embodiments, eligible parlance may include a depiction of regression results with sufficient enough information reported to conclude that numeric values represented standardized regression betas rather than unstandardized regression betas (i.e. the interpretations of each being different from the other). For example, one instance of parlance considered ineligible might include ‘eligible formats’ suggesting a type of analysis (e.g. regression), but not reporting enough information, or not consistently reporting information, such that numeric values cannot be transformed conclusively as standardized or unstandardized. In another example, other forms of ineligible parlance may occur, such as cases where statistical information provided is conclusive, but the reporting in the ‘table’ is such that the direction of the relational data is unclear.

FIG. 6 illustrates the method may also include determining whether the ineligible table content parlance is framed 610 by referent language. In accordance with embodiments, referent language refers to the presence or absence of language located outside or away from a particular table lacking eligible parlance that makes relational data conclusive. For example, referent language may comprise a footnote adjacent to the ‘table’ that allows for a conclusion to be drawn regarding information in a ‘table.” As shown in FIG. 6, the presence of ‘referent language’ returns the table content to eligible parlance. FIG. 6 illustrates the method may also include grouping 608 tables by unique sample instances. In accordance with embodiments, the sample instance may comprise one or more individual gatherings of data analyzed in an article.

FIG. 6 illustrates the method may also include counting 612 tables for each sample instance. In accordance with embodiments, each table may represent one or more models comprising a set of variables which are tested together. As illustrated in FIG. 6, the method may include determining 614 the number of relational paths in each table. For example, each table may comprise one or more models reflecting sets of variables which are tested together. FIG. 6 also illustrates identifying 616 the terminal models in response to determining the number of relational paths in each table. FIG. 6 also illustrates the method may include determining 618 whether the paths are framed by referent language in response to determining the number of paths are not determinable. In accordance with embodiments, referent language may comprise the presence or absence of language located outside of the table that makes the paths determinable. For example, referent language may comprise, but is not limited to, text in a results section of a content source that provides confirmation or clarifies ambiguity regarding information in a table. FIG. 6 also illustrates that in response to determining 618 the paths are framed by referent language the method may return to the step of identifying 616 the terminal models.

Also illustrated in FIG. 6, the method may include determining 620 whether the referent language indicates one or more terminal models. FIG. 6 illustrates in response to determining the referent language indicates one or more terminal models, counting 622 the one or more terminal models. Also illustrated in FIG. 6, the method may include recording 624 terms and designating path types. In accordance with embodiments, recording 624 may comprise inspecting a coefficient type associated with a terminal model of the one or more terminal models.

FIG. 6 also illustrates the method may include determining 626 whether the term matches a term in a corpus of terms. In response to determining the term does not match a term in the corpus of terms, FIG. 6 illustrates the method may include adding 628 the term to the corpus of terms and adjusting existing synonyms associated with the corpus of terms. FIG. 6 also illustrates the method may include determining 630 whether the term is associated with a parent term of the corpus of terms. In response to determining the term is not associated with a parent term, FIG. 6 illustrates the method may include adding 632 a parent term to the corpus of terms and adjusting existing parent synonyms associated with the corpus of terms.

The method of FIG. 6 may also include recording 634 the path coefficient by eligible format. In accordance with embodiments, the step of recording 634 may comprise determining the type of path for the terminal model. FIG. 6 also illustrates the method may include determining 636 whether the path is significant and the associated level of significance. The method of FIG. 6 may also include determining 638 whether the term value is in the corpus of terms and in response to determining the term value is not in the corpus, adding the term to the corpus of terms. In accordance with embodiment, the term values may correspond to term values across multiple different artifacts. FIG. 6 also illustrates the method may include determining 640 whether the term descriptors are in the corpus of terms and in response to determining the term descriptors are not in the corpus, adding the term descriptors to the corpus.

FIG. 6 illustrates the method may include determining 642 whether a term definition matches term definitions in the corpus of terms and in response to determining the term definitions are not in the corpus of terms, adding the term definitions to the corpus of terms. In accordance with embodiment, the term definitions may correspond to term definitions across multiple different artifacts. As illustrated in FIG. 6, the method may include designating 644 the term unit. In accordance with embodiments, the term unit comprises a unit of analysis for reporting results within the artifact. For example, a unit of analysis may comprise reporting results from an individual, group of individuals, or a team of individuals along with the type of source of the reporting. The method of FIG. 6 may include recording 646 the artifact as a reference and completing 648 transformation of the artifact within the system of the present disclosure.

Returning to FIG. 2, the method may also include communicating 206 the one or more relationships to one or more relational databases configured to index the one or more relationships. For example, FIG. 1 illustrates computing device 102 is configured to communicate the one or more relationships 122 to one or more relational databases 128 configured to index the one or more relationships 122. In one embodiment, the one or more relational databases are configured to index the one or more relationships to facilitate taxonomic organization of relational content. For example, the relational databases 128 of FIG. 1 may be configured to index the one or more relationships by storing the one or more relationships in one or more tables within relational databases 128. In this example, the relational databases 128 may also be configured to store the one or more variables in one or more tables within relational databases 128. Also in this example, the one or more tables within relational databases 128 may be configured to reference each other to facilitate the taxonomic organization of the one or more relationships and their associated content.

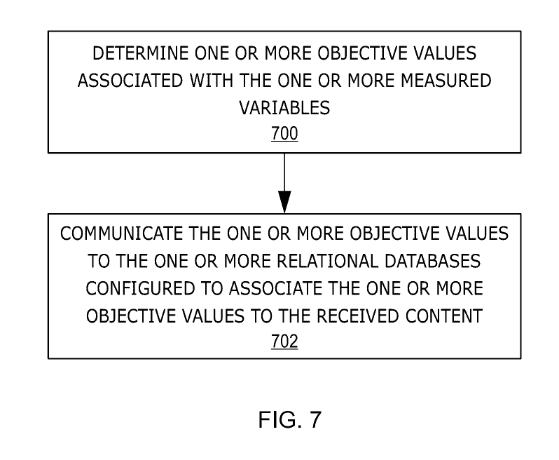

In accordance with embodiments of the present disclosure, FIG. 7 illustrates the method may also include determining 700 one or more objective values associated with the one or more measured variables. For example, FIG. 1 illustrates computing device 102 may be configured to determine one or more objective values 126 associated with the one or more measured variables 120. In accordance with embodiments, the one or more objective values may comprise one of a statistical significance value, effect size value, sample size value, time period value, analysis type value, report type value, sample type value, and sample descriptor value. In accordance with embodiments, the statistical significance value may comprise a value indicating whether the relationship between the one or more measured variables is a reliable interpretation of the data or analysis utilized. In accordance with embodiments, the effect size value may comprise a value indicating the extent of the relationship between two measured variables. In accordance with embodiments, the sample size value may comprise a metric indicating whether the analysis of a relationship between two measured variables should comprise a minimum sample size in order for the relationship findings to be considered reliable. In accordance with embodiments, the time period value may comprise a time value indicating all data gathered was gathered at a single point in time via a cross-sectional analysis. In accordance with embodiments, the time period value may comprise a time value indicating data for one measured variable may have been gathered at one point in time and data for another measured variable may have been gathered at a later point in time. In accordance with embodiments, the analysis type value may indicate whether the relationship between two measured variables was reported in one of a standardized form and an unstandardized form. For example, the effect size of a relationship between two measured variables reported in “standardized” form cannot necessarily be directly compared with the effect size of a relationship between two other measured variables reported in an “unstandardized” form.

Also in accordance with embodiments, the report type value may indicate a classification of the type of reporting associated with the data of the content. For example, the report type value may indicate the data within the content was self-reported by a study participant or reported by another person associated with the study. In another example, the report type value may indicate the data of the content is associated with multiple different types of reporting. In a further example, the reporting type value may indicate that the data of the content is archival. In this example, the data of the content is collected prior to the beginning of the study, and thus is considered archival.

In accordance with embodiments, the sample type value may indicate a classification of a method of sample selection associated with the data of the content. For example, the sample type value may indicate a random sample selection type. In this example, the random sample selection comprises a statistical sampling of the general population where every individual has the same chance of being selected to participate. In another example, the sample type value may indicate a purposive sample selection type. In this example, the purposive sample is a non-probability sample where individuals are selected based on characteristics of a population. In a further example, the sample type value may indicate a convenience sampling type. In this example, the convenience sample is a non-probability sample where individuals are selected because they are easy to reach.

The sample descriptor value may comprise information associated with one of the sample size value and the sample type value in accordance with embodiments. For example, the sample descriptor value may identify information associated with participants of a study. In this example, the sample descriptor value may comprise a text value identifying the final sample number of participants. In another example, the sample descriptor value may comprise one of a country of study, age characteristic, name of formal study, or relationship of study participants.

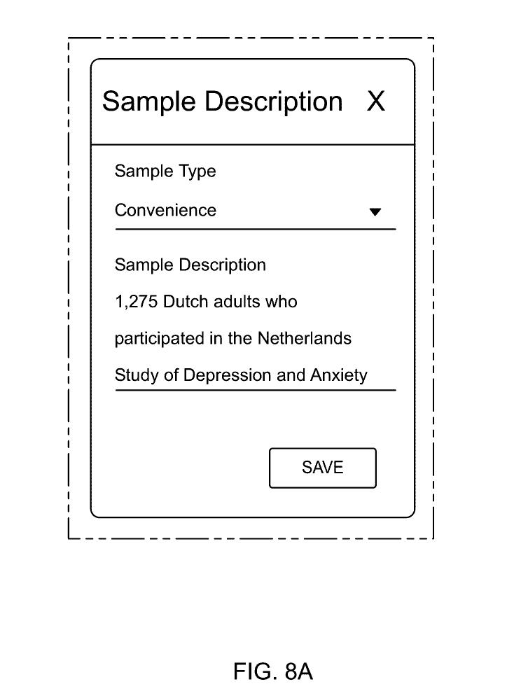

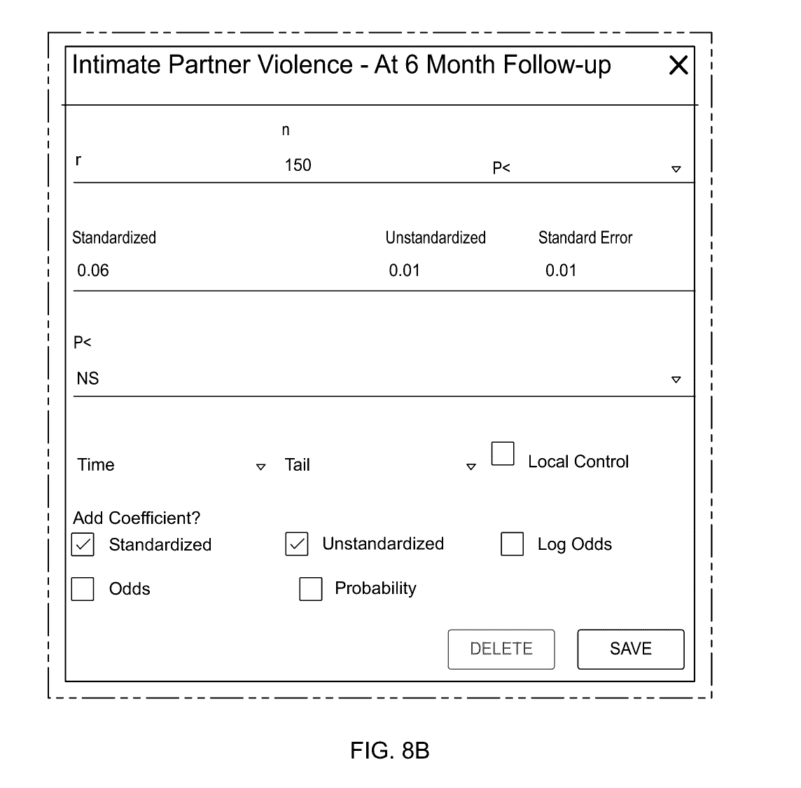

In accordance with embodiments, the method may include receiving information to associate with an objective value. For example, computing device 102 may be configured to receive information to associate with an object value 126. FIG. 8A is a screen display of an example user interface for receiving a sample type and sample description objective value in accordance with embodiments of the present disclosure. FIG. 8B is a screen display of an example user interface for receiving an analysis type objective value in accordance with embodiments of the present disclosure. It should be understood to one of ordinary skill in the art that the examples provided in FIGS. 8A-8B are examples only and not intended to limit the scope of the objective values defined above.

Returning to FIG. 7, the method may also include communicating 702 the one or more objective values to the one or more relational databases configured to associate the one or more objective values to the received content. For example, FIG. 1 illustrates computing device 102 may be configured to communicate the one or more objective values 124 to the one or more relational databases 128 configured to associate the one or more objective values 124 to the received content 108 and/or 114.

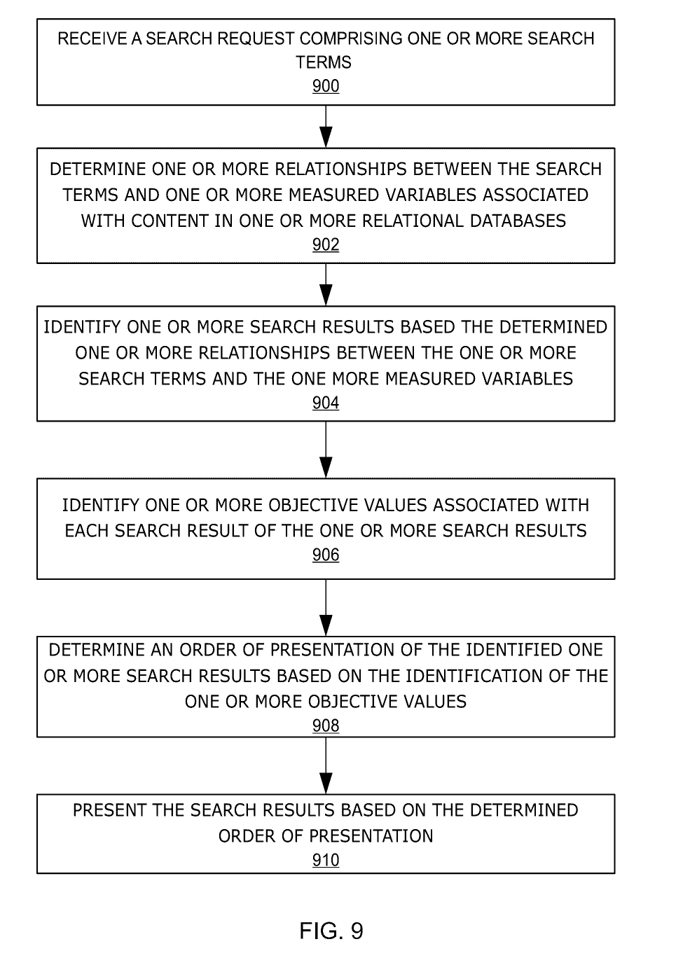

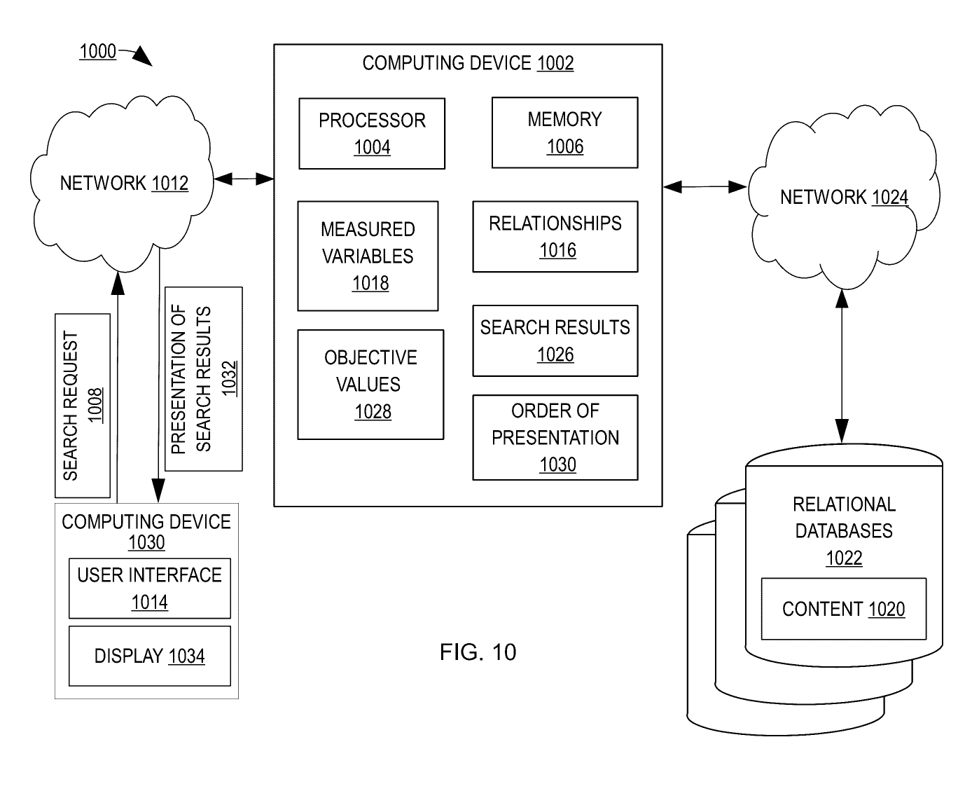

FIG. 9 is a flowchart of an example method of determining one or more relationships between the search terms and one or more measured variables associated with content in a relational database in accordance with embodiments of the present disclosure. As shown in FIG. 9, the method may include receiving 900 a search request comprising one or more search terms. In one embodiment, the search request may be received from another computing device. For example, FIG. 10 illustrates a system 1000 comprising a computing device 1002 comprising a processor 1004 and memory 1006. In this example, computing device 1002 and its corresponding processor 1004 and memory 1006 may be configured to receive a search request 1008 from computing device 1010 via network 1012. For example, a user of computing device 1010 may submit the search request 1008 via user interface 1014 of computing device 1010 for delivery to computing device 1002. In this example, computing device 1010 may comprise a display 1034 in which the user of computing device 1010 may interact with user interface 1014.

Returning to FIG. 9, the method may include determining 902 one or more relationships between the search terms and one or more measured variables associated with content in a relational database. In accordance with embodiments, the content may comprise one of scientific, academic, and research-oriented data from a content source. Also in accordance with embodiments, the one or more measured variables may comprise one of a predictor variable and outcome variable associated with the content. For example, FIG. 10 illustrates computing device 1002 may be configured to determine one or more relationships 1016 between the search terms of search request 1008 and one or more measured variables 1018 associated with content 1020 in relational databases 1022. In accordance with embodiments, the method of determining 902 one or more relationships between the search terms and the one or more measured variables may comprise comparing the one or more search terms to the one of a predictor variable and outcome variable. Continuing the previous example, FIG. 10 illustrates computing device 1002 may be configured to compare the one or more search terms of search request 1008 to the one of a predictor variable and outcome variable of the measured variables 1018. In accordance with embodiments, the method of determining 902 one or more relationships between the search terms and the one or more measured variables may also comprise determining the one or more relationships based upon the comparison.

FIG. 9 also illustrates the method may include identifying 904 one or more search results based on the determined one or more relationships between the one or more search terms and the one or more measured variables. For example, FIG. 10 illustrates computing device 1002 may be configured to identify one or more search results 1026 based on the determined one or more relationships 1016 between the one or more search terms of search request 1008 and the one or more measured variables 1018. In accordance with embodiments, FIG. 9 also illustrates the method may include identifying 906 one or more objective values associated with each search result of the one or more search results. For example, FIG. 10 illustrates computing device 1002 may be configured to identify one or more objective values 1028 associated with each search result of the one or more search results 1026. In one embodiment, the one or more objective values comprise one of a statistical significance value, effect size value, time period value, analysis type value, report type value, sample type value, sample size value, and sample descriptor value.

The method, as shown in FIG. 9, may include determining 908 an order of presentation of the identified one or more search results based on the identification of the one or more objective values. For example, FIG. 10 illustrates that computing device 1002 may be configured to determine an order of presentation 1030 of the identified one or more search results 1026 based on the identification of the one or more objective values 1028. In accordance with embodiments, the order of presentation may be based on the value of the one or more objective values. Also in accordance with embodiments, the order of presentation may be based on one of an increasing and decreasing value of the one or more objective values.

Returning to FIG. 9, the method may include presenting 910 the search results based on the determined order of presentation. For example, FIG. 10 illustrates computing device 1002 may be configured to present the search results 1026 based on the determined order of presentation 1030. In this example, computing device 1002 may be configured to deliver the presentation of the search results 1032 to computing device 1010 for presentation to a user of computing device 1010 via user interface 1014. As mentioned previously, computing device 1010 may be configured to present user interface 1014 via display 1034.

In accordance with embodiments, the order of presentation may be based on the type and value of the one or more objective values. Also in accordance with embodiments, the method may include determining a validity value for each search result based on the type and value for each objective value of the one or more objective values of the one or more measured variables associated with the search result. In accordance with embodiments, each objective value is associated with a specific weighting value based on the type and value of the objective value. In accordance with embodiments, the method may include determining an order of the presentation of the search results based the validity value associated with each search result.

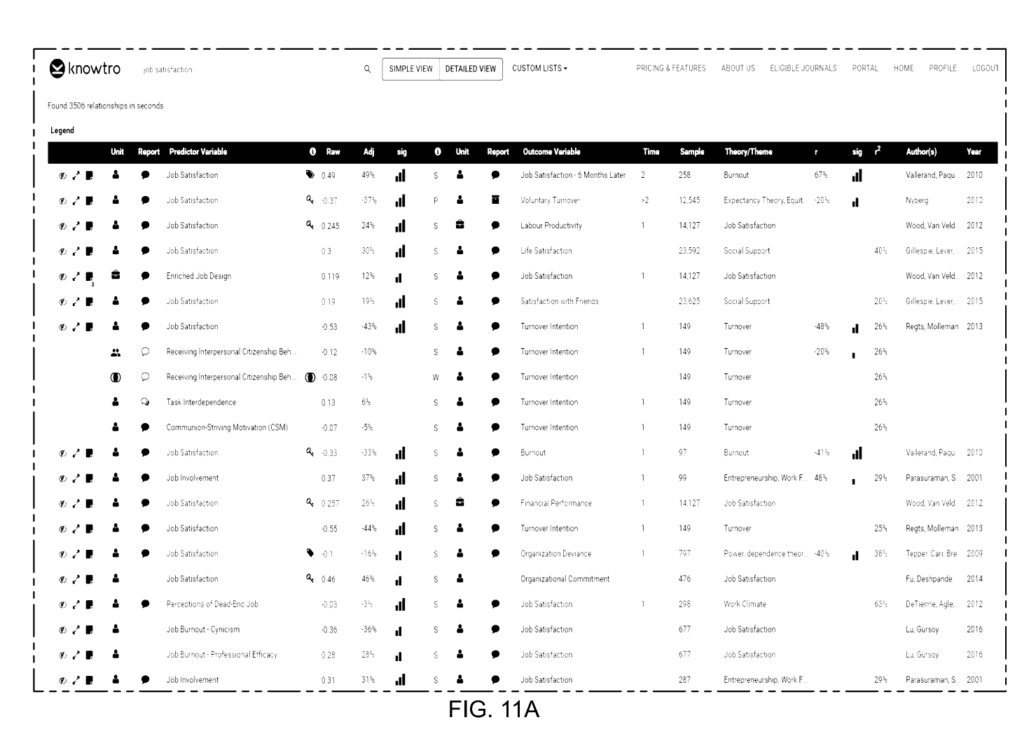

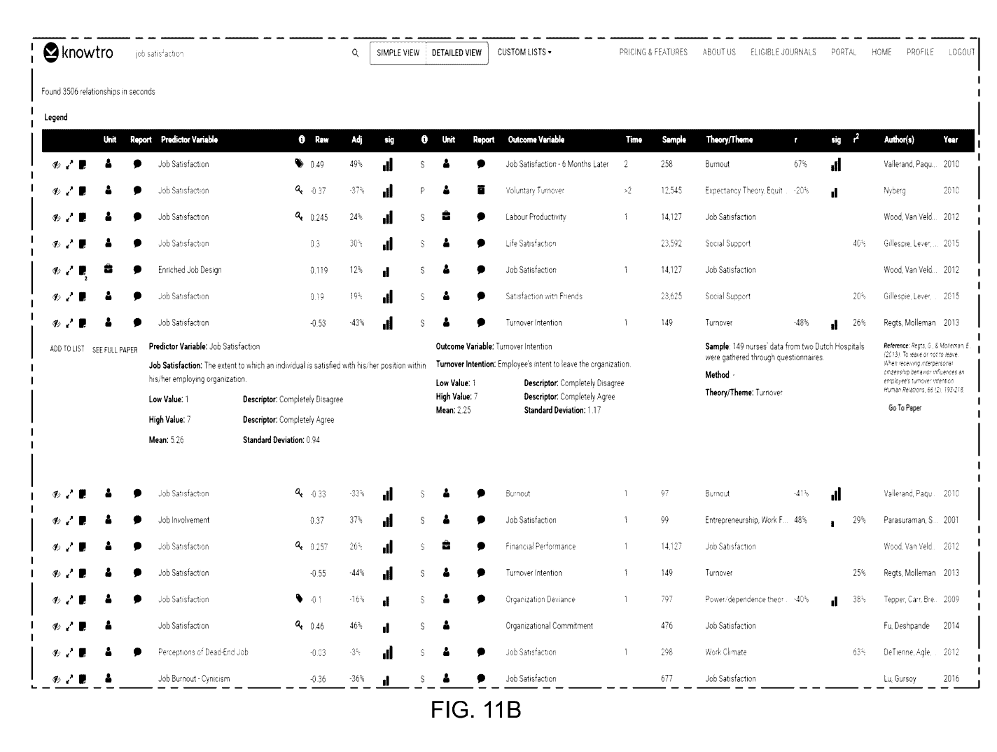

FIG. 11A is a screen display of an example user interface displaying search results in accordance with embodiments of the present disclosure. For example, FIG. 11A illustrates the order of presentation may be based on the type and value the one or more objective values, such as, but not limited to, sample size value “Sample,” random type value “r,” time value “T,” and the other objective values illustrated. In this example, the “Vallerand” reference is listed first as the method and system determined this reference to possess the most valid type of results.

FIG. 11B is a screen display of another example user interface displaying search results in accordance with embodiments of the present disclosure. In accordance with embodiments, each result of the search results may be selectable via the user interface for viewing information associated with each result. In this view, a particular set of predictor variable and outcome variable has been selected for further review by a user. Also shown in this view, the objective values associated with the predictor variable “Job Satisfaction” and outcome variable “Turnover Intention” and their associated text descriptions and values are displayed via the user interface.

In accordance with embodiments of the present disclosure, the method may include determining a subset of search results to exclude from the identified one or more search results and excluding the subset of search results from the presentation of the search results. For example, computing device 1002 of FIG. 10 may be configured determine a subset of search results to exclude from the identified one or more search results 1026 and to exclude the subset of search results from the presentation of the search results 1032. In accordance with embodiments, the method of determining a subset of search results to exclude may comprise determining the subset of the search results comprises one of missing information, unreported information, redundant information, local control setting, and low effect significance. For example, computing device 1002 of FIG. 10 may be configured to determine the subset of the search results comprises one of missing information, unreported information, redundant information, local control setting, and low effect significance.

In accordance with embodiments, the redundant information may indicate two or more relationships within the same sample comprising identical predictor variables and outcome variables. Also in accordance with embodiments, the local control setting may indicate a control variable within the data of the content. In one embodiment, the control variable may be specific to the design of a study. In another embodiment, the control variable may control for past performance of a measured variable while a current or future performance of the measured variable is measured. In accordance with embodiments, the low effect significance may indicate a quality of statistical significance of a relationship between the predictor variable and outcome variable. In this embodiment, the statistical significance may indicate the probability that the relationship between the predictor variable and the outcome variable is one of truth or of chance. For example, the lower the statistical significance, the less confident the relationship is a true relationship.

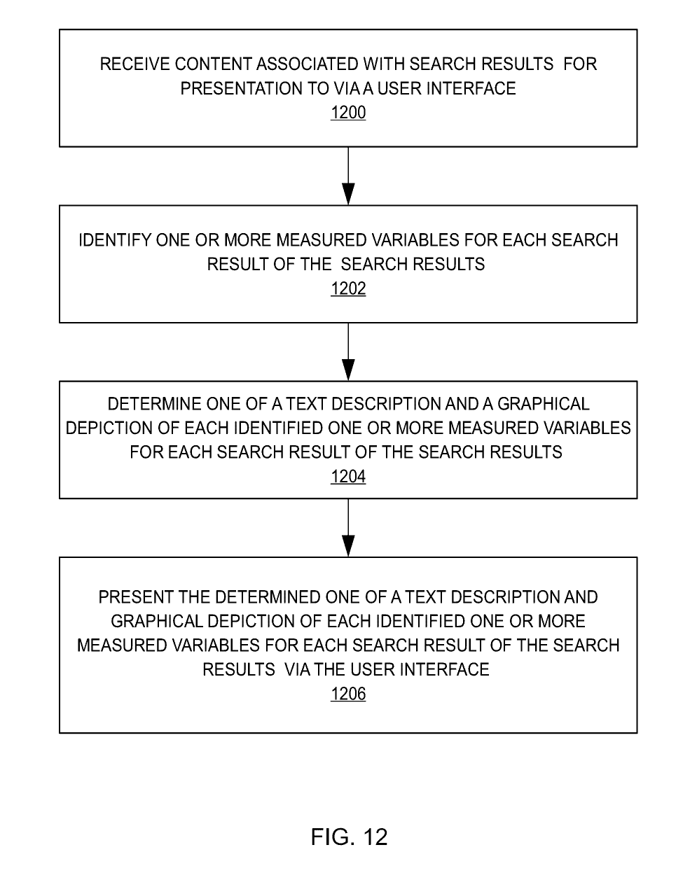

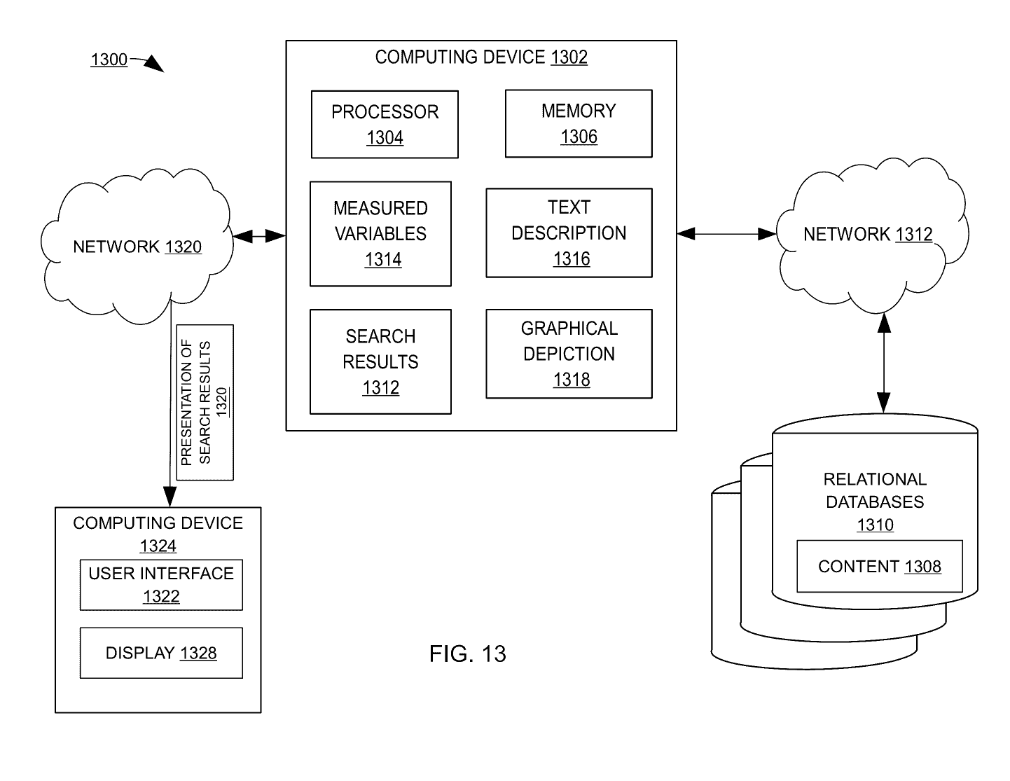

FIG. 12 illustrates a method of determining one of a text description and a graphical depiction of each identified one or more measured variables for each search result of the search results in accordance with embodiments of the present disclosure. As shown in FIG. 12, the method includes receiving 1200 content associated with search results for presentation via a user interface. In accordance with embodiments, the method of receiving 1200 the content may comprise receiving the content associated with the search results from one or more relational databases. For example, FIG. 13 illustrates a system 1300 comprising a computing device 1302 comprising a processor 1304 and memory 1306. In this example, FIG. 13 illustrates computing device 1302 and processor 1304 and memory 1306 may be configured to receive content 1308 associated with search results 1310 for presentation via user interface 1312 computing device 1314. As shown in FIG. 13, computing device 1302 may be configured to receive content 1308 associated with the search results 1310 from one or more relational databases 1316 via network 1318.

Returning to FIG. 12, the method may also include identifying 1202 one or more measured variables for each search result of the search results. For example, FIG. 13 illustrates computing device 1302 may be configured to identify one or more measured variables 1320 for each search result of the search results 1310. The method may also include, as shown in FIG. 12, determining 1204 one of a text description and a graphical depiction of each identified one or more measured variables for each search result of the search results. For example, FIG. 13 illustrates computing device 1302 may be configured to determine one of a text description 1322 and a graphical depiction 1324 of each identified one or more measured variables 1320 for each search result of the search results 1310.

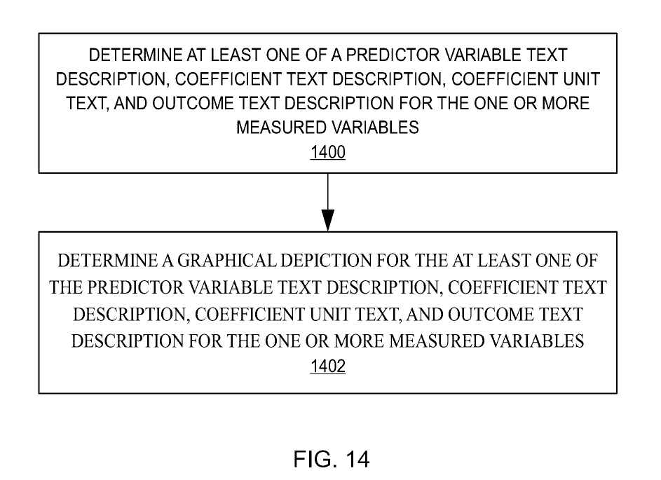

In accordance with embodiments, FIG. 14 illustrates the method of determining 1204 a text description may include determining 1400 at least one of a predictor variable text description, coefficient text description, coefficient unit text, and outcome text description for the one or more measured variables. For example, FIG. 13 illustrates computing device 1302 may be configured determining at least one of a predictor variable text description, coefficient text description, coefficient unit text, and outcome text description for the one or more measured variables 1320. Returning to FIG. 14, the method may include determining 1402 a graphical depiction for the at least one of the predictor variable text description, coefficient text description, coefficient unit text, and outcome text description for the one or more measured variables. For example, FIG. 13 illustrates computing device 1302 may be configured to determine a graphical depiction 1318 for the at least one of the predictor variable text description, coefficient text description, coefficient unit text, and outcome text description for the one or more measured variables 1320.

In accordance with embodiments of the present disclosure, the method of determining a predictor variable text description may comprise determining whether the predictor is binary or non-binary. In response to determining the predictor is binary, a text description associated with a binary type predictor variable text description may be selected in accordance with embodiments. In response to determining the predictor is non-binary, the method may include determining whether the relationship is standardized or non-standardized in accordance with embodiments. In response to determining the relationship is non-standardized, a text description associated with a non-standardized relationship may be selected as the predicator variable text description in accordance with embodiments. In response to determining the relationship is standardized, a text description associated with a standardized relationship may be selected as the predicator variable text description.

In accordance with embodiments, the method may include determining a coefficient text description for the one or more measured variables. In accordance with embodiments, determining a coefficient text description may include determining whether the relationship is significant. In response to determining the relationship is not significant, a text description associated with a relationship that is not significant may be selected as the coefficient description in accordance with embodiments. In response, to determining the relationship is significant, a text description associated with a relationship that is significant may be selected as the coefficient description in accordance with embodiments.

Also in accordance with embodiments of the present disclosure, the method may include determining a coefficient unit text description for the one or more measured variables. The method may include determining whether a coefficient unit variable of the one or more measured variables indicates a percentage in accordance with embodiments. In response to determining the coefficient unit variable indicates a percentage, a text description associated with a percentage value may be selected as the coefficient unit text description in accordance with embodiments. For example, a coefficient unit text description indicating a percentage may comprise a coefficient unit associate with a mean comparison. In another example, a coefficient unit text description indicating a percentage may comprise one of a log odd and odds ratio.

In another example, a coefficient unit text description indicating a percentage may comprise an unstandardized coefficient unit accompanied by low and/or high descriptors. In another example, a coefficient unit text description indicating a percentage may comprise unstandardized coefficient unit and accompanied by binary low and high values. In a further example, a coefficient unit text description indicating a percentage may comprise an unstandardized coefficient unit accompanied by low and high values that represent a non-binary discrete range.

In response to determining the outcome variable does not indicate a percentage, the method may include determining whether the relationship is standardized in accordance with embodiments. In response to determining the relationship is standardized, a text description associated with the standardized relationship may be selected as the coefficient unit text description in accordance with embodiments. In response to determining the relationship is not standardized, a text description associated with the non-standardized relationship may be selected as the coefficient unit text description in accordance with embodiments.

In accordance with embodiments of the present disclosure may include determining an outcome text description for the one or more measured variables. In accordance with embodiments, the method may include determining whether a value of an outcome variable of the one or more measured variables is binary or a probability. In response to determining the value of an outcome variable is a probability, a text description associated with the probability value may be selected as the outcome description in accordance with embodiments. In response to determining the outcome variable of the one or more measured variables is binary, a text description associated with the binary value may be selected as the outcome description in accordance with embodiments.

Returning to FIG. 12, the method may also include presenting 1206 the determined one of a text description and graphical depiction of each identified one or more measured variables for each search result of the search results via the user interface. For example, FIG. 13 illustrates computing device 1302 may be configured to present the determined one of a text description 1322 and graphical depiction 1324 of each identified one or more measured variables 1320 for each search result of the search results 1310 via the user interface 1312. In this example, FIG. 13 illustrates computing device 1302 may be configured to deliver the presentation 1326 of the search results 1310 via user interface 1312 of computing device 1314. FIG. 13 also illustrates a user of computing device 1314 may access user interface 1312 via display 1328 of computing device 1314. FIG. 13 also illustrates that the presentation 1326 of search results 1310 may be communicated to computing device 1314 over network 1330.

In accordance with embodiments, the graphical depiction of the one or more measured variables is determined by the content of the determined text description of the one or more measured variables. For example, the graphical depiction 1324 of the one or more measured variables 1320, as illustrated in FIG. 13, is determined by the content of the determined text description 1322 of the one or more measured variables 1320.

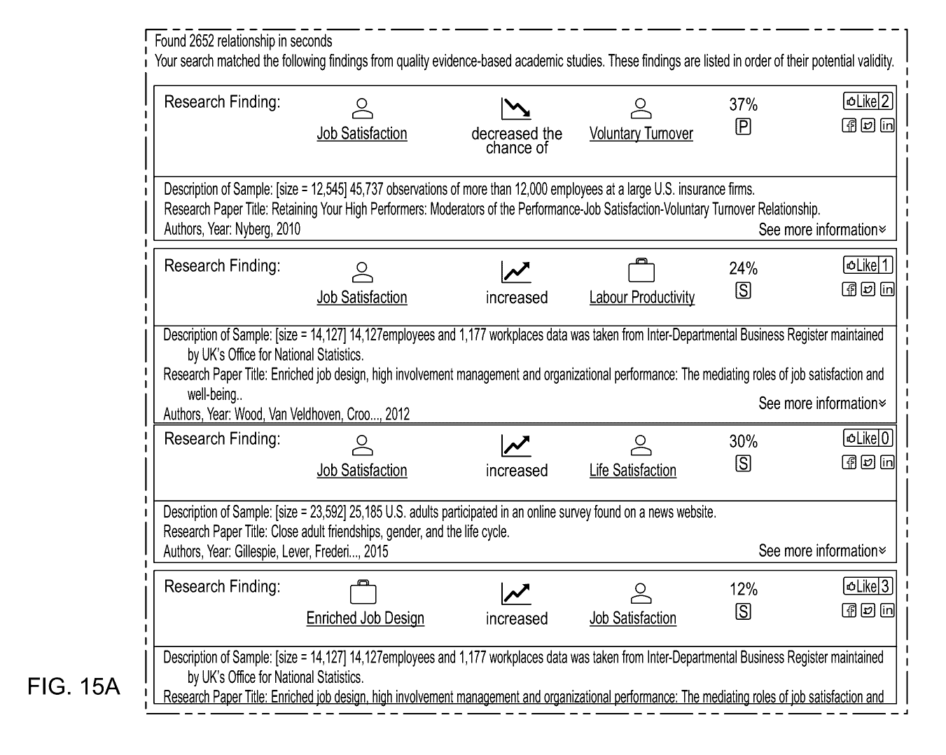

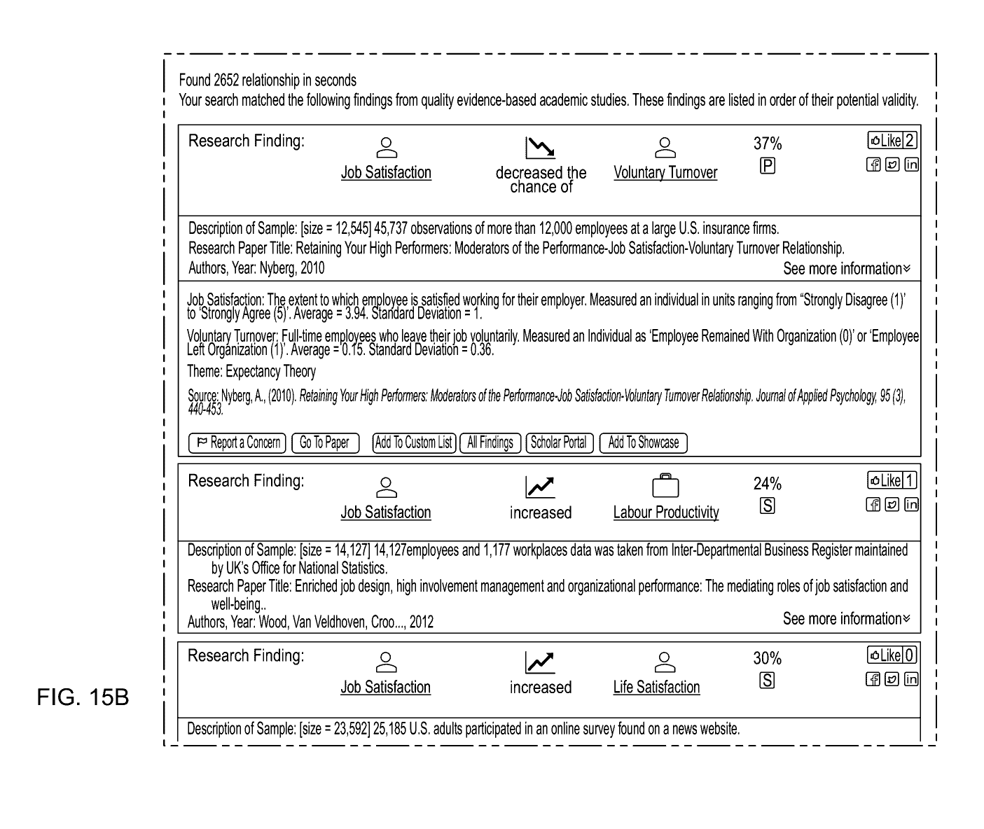

FIG. 15A is a screen display of an example user interface for displaying a text description and graphical depiction of each identified one or more measured variables for each search result of search results in accordance with embodiments of the present disclosure. For example, FIG. 15A illustrates an example of presenting the determined text description “decreased the chance of” and graphical depiction of a decreasing arrow depicting a relationship between the measured variables “Job Satisfaction” and “Voluntary Turnover” of the first search result of the list of search results via an internet user interface. Also shown in FIG. 16A, the graphical depiction of the text description “decreased the chance of” includes an icon comprising a downward directed arrow.

FIG. 15A also illustrates displaying the type of coefficient unit associated with each search result. For example, FIG. 15A illustrates the first search result is associated with a probability, or “P,” type of coefficient. In another example, FIG. 15A illustrates the second search result is associated with a standardized, or “S,” type of coefficient. Although not shown, another example may comprise indicating a one-unit increase in the term on the left was related to the term on the right as a percentage of the total range of units of the term on the right. Also not shown, another example may comprise indicating a one-unit increase in the term on the left was related to the change in the units shown in the term on the right.

FIG. 15B is a screen display of another example user interface for displaying a text description and graphical depiction of each identified one or more measured variables for each search result of search results in accordance with embodiments of the present disclosure. For example, FIG. 16B illustrates additional information regarding the measured variables “Job Satisfaction” and “Voluntary Turnover” may be obtained by a user selecting the search result via the user interface. For example, FIG. 13 illustrates computing device 1302 may be configured to alter the presentation 1326 of the search results by a user of computing device 1314 selecting the search result via the user interface 1312 on display 1328.

An advantage of the presentation of search results described herein above allows for the distillation of source material from lengthy, technically-dense text and data into easy-to-read expressions that highlight individual takeaways from the technically-dense text and data. The present disclosure enables laypeople to quickly ascertain the nature and quality of an individual piece of scientific, academic, or research-oriented content. In addition, the present disclosure also enables laypeople to move easily from one discipline of science to another and even make comparisons among relational data from various sources, and disciplines, simultaneously.

In accordance with embodiments of the present disclosure, the method may also include determining a text description and a graphical depiction of one or more objective values for each search result of the search results in accordance with embodiments of the present disclosure. Also in accordance with embodiments, the method may also include presenting the determining text description and graphical depiction of the one or more objective values for each search result of the search results via the user interface. For example, FIG. 11A is also a screen display of another example user interface for displaying a text description and graphical depiction of each identified one or more measured variables for each search result of the search results in accordance with embodiments of the present disclosure. In this example, FIG. 11A is also a screen display of an example user interface for displaying text description and graphical depiction of the one or more objective values for each search result of the search results in accordance with embodiments of the present disclosure.

As illustrated in FIG. 11A, the text description and graphical depiction of each identified one or more measured variables and their associated objective values for each search result of the search results in a tabular form. For example, FIG. 11A illustrates presenting the text description “Job Satisfaction” of one measured variable along with graphical depictions of the objective values unit of measurement “Unit,” reporting type value “Report,” and statistical significance “sig.” For example, FIG. 11A illustrates the unit of measurement for the “Vallerand” result comprises an individual, or a single person icon, representing measuring individual level characteristics. In the same example, FIG. 11A illustrates the unit of measurement for the “Wood” result comprises an organization, or a suitcase icon, representing measuring organizational level characteristics. It should be understood that the graphical icons depicted in FIGS. 11A are illustrative only and should not be construed to limit the types of graphical icons that may be utilized to depict the measured variables of the present disclosure.

An advantage of the presentation of search results in a tabular view described herein above enables a user familiar with scientific, academic, and research-oriented information to quickly analyze the search results with more robust information. In addition, the tabular view described herein above may enable a higher level analysis, including observations about broad scientific, academic, and research-oriented practices. The present disclosure improves the sophistication with which a user familiar with scientific, academic, and research-oriented information may review extant work, discover gaps in scientific understanding, and understand details about the research design, sampling, and analysis of the search results.

As shown herein above, the methods and systems of the present disclosure demonstrate an improvement over previously known methods and systems for obtaining and delivering search results comprising scientific, academic, and research-oriented information. Also shown above, the methods implemented in the systems above improve the functionality of those systems to enable the systems to obtain and deliver search results comprising scientific, academic, and research-oriented information. The present disclosure also demonstrates the methods and systems disclosed herein deliver concrete, physical, and non-abstract results. The present disclosure also demonstrates a general computing device, per se, would only be able perform the methods disclosed herein if specifically configured to perform the methods disclosed herein.

The present subject matter may be a system, a method, and/or a computer program product. The computer program product may include a computer readable storage medium (or media) having computer readable program instructions thereon for causing a method or to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While certain embodiments have been described, these embodiments have been presented by way of example only, and are not intended to limit the scope of the inventions. Indeed, the novel methods, devices, and systems described herein may be embodied in a variety of other forms. Furthermore, various omissions, substitutions, and changes in the form of the methods, devices, and systems described herein may be made without departing from the spirit of the inventions. The accompanying claims and their equivalents are intended to cover such forms or modifications as would fall within the scope and spirit of the inventions.

What is claimed:

1. A method comprising:
at a computing device comprising at least one processor and memory:
receiving content comprising one of scientific, academic, and research-oriented data from a content source;
determining one or more measured variables related to the one of scientific, academic, and research-oriented data of the content;
determining one or more relationships between the received content and previously received content based on the determined one or more measured variables; and
communicating the one or more relationships to one or more relational databases configured to index the one or more relationships.

2. The method of claim 1, wherein the content source comprises a database associated with the one of scientific, academic, or research-oriented data.

3. The method of claim 1, wherein the content source comprises another computing device in communication with the computing device.

4. The method of claim 1, wherein the one or more measured variables comprise one of a predictor variable and outcome variable associated with the one of scientific, academic, and research-oriented data.

5. The method of claim 1, wherein determining the one or more measured variables comprises receiving identification of the one or more measured variables.

6. The method of claim 6, wherein receiving the identification comprises receiving a selection of the one or more measured variables from a list of previously determined one or more measured variables.

7. The method of claim 1, wherein determining the one or more relationships between the received content and previously received content based on the determined one or more measured variables comprises:
comparing the one or more measured variables to previously determined measured variables related to the previously received content; and
identifying the one or more relationships based on the comparison.

8. The method of claim 1, further comprising:
determining one or more objective values associated with the one or more measured variables; and
communicating the one or more objective values to the one or more relational databases configured to associate the one or more objective values to the received content.

9. The method of claim 7, wherein the one or more objective values comprise one of a statistical significance value, effect size value, sample size value, time period value, analysis type value, report type value, sample type value, sample size value, and sample descriptor value.

10. A method comprising:
at a computing device comprising at least one processor and memory:
receiving a search request comprising one or more search terms;
determining one or more relationships between the search terms and one or more measured variables associated with content in one or more relational databases;
identifying one or more search results based on the determined one or more relationships between the one or more search terms and the one more measured variables;
identifying one or more objective values associated with each search result of the one or more search results;
determining an order of presentation of the identified one or more search results based on the identification of the one or more objective values; and
presenting the search results based on the determined order of presentation.

11. The method of claim 10, wherein the content comprises one of scientific, academic, and research-oriented data from a content source.

12. The method of claim 10, wherein the one or more measured variables comprise one of a predictor variable and outcome variable associated with the content.

13. The method of claim 12, wherein determining one or more relationships between the search terms and one or more measured variables associated with content in a relational database comprises:
comparing the one or more search terms to the one of a predictor variable and outcome variable; and
determining the one or more relationships based upon the comparison.

14. The method of claim 10, wherein the one or more objective values comprise one of a statistical significance value, effect size value, sample size value, time period value, analysis type value, report type value, sample type value, sample size value, and sample descriptor value.

15. The method of claim 10, further comprising:
determining a subset of search results to exclude from the identified one or more search results;
excluding the subset of search results from the presentation of the search results.

16. The method of claim 15, wherein determining a subset of search results to exclude from the identified one or more search results comprises:
determining the subset of the search results comprises one of missing information, unreported information, redundant information, local control setting, and low effect significance.

17. A method comprising:
at a computing device comprising at least one processor and memory:
receiving content associated with search results for presentation via a user interface;
identifying one or more measured variables for each search result of the search results;
determining one of a text description and graphical depiction of each identified one or more measured variables for each search result of the search results; and
presenting the determined one of a text description and graphical depiction of each identified one or more measured variables for each search result of the search results via the user interface.

18. The method of claim 17, wherein receiving the search results comprises receiving the search results from one or more relational databases.

19. The method of claim 17, wherein determining one of a text description and graphical depiction of each identified one or more measured variables comprises:
determining at least one of a predictor variable text description, coefficient text description, coefficient unit text, and outcome text description for the one or more measured variables; and
determining a graphical depiction for the at least one of the predictor variable text description, coefficient text description, coefficient unit text, and outcome text description for the one or more measured variables.

20. The method of claim 17, wherein the graphical depiction of the one or more measured variables is determined by the content of the determined text description of the one or more measured variables.
